(19) United States
(12) Patent Application Publication
(10) Pub. No.: US 2008/0307190 A1
(43) Pub. Date: Dec. 11, 2008

(54) System and Method for Improved Virtual Real Memory

(76) Inventors: Richard Louis Arndt, Austin, TX (US); Bradly George Frey, Austin, TX (US)

Correspondence Address: IBM Corporation (PEC);c/o Patrick E. Caldwell, Esq., The Caldwell Firm, LLC, PO Box 59655, DALLAS, TX, 75229-0655, US

(21) Appl. No.: 11/759,685

(22) Filed: Jun. 7, 2007

(51) Int. Cl. G06F 12/00

(52) U.S. Cl. 711/203

(57) ABSTRACT

A method for providing virtual real memory includes receiving a request for a memory page from a requestor. A system determines whether the requested memory page is available. In the event the requested memory page is available, the system satisfies the request. In the event the requested memory page is not available, the system generates a page fault interrupt, wherein the page fault interrupt comprises a first page fault correlation number (PFCID) identifying a restorative process, and wherein the restorative process is configured to restore the requested memory page to available memory. The system monitors a plurality of pending processes and determines whether the restorative process is complete. In the event the restorative process is complete, the system notifies the requester that the restorative process is complete.

### TECHNICAL FIELD

The present invention relates generally to the field of computer operations processing and, more particularly, to a system and method for improved virtual real memory.

### BACKGROUND OF THE INVENTION

Modern electronic devices, such as computers, for example, often include a virtual image of certain real, physical resources. For example, virtual memory is a well-known technique to configure a local memory domain to appear larger than the physical resource in which it is embodied. Some computer systems also include a virtual image of the main storage space, known as Virtual Real Memory (VRM). Under typical VRM protocols, a computer platform appears to an operating system (OS) or other virtual machine (VM) to have more main storage available than is physically present. As such, VRM is similar to a virtual memory OS, which appears to underlying applications and/or processes to have more local memory storage available than is physically present.

In many instances, VRM operates transparently to the OS or other virtual machines, just as an operating system makes its virtual memory transparent to its application programs. However, if one of the memory pages that an application, virtual machine, or OS is trying to access is paged out by the VRM function, in many systems, the VRM blocks the requesting VM/OS from further operation until the requested memory page is resident in the physical memory or is otherwise restored. This problem is even more pronounced in systems with multiple processors. In some prior art systems, this blockage can cause a cascading stall condition, wherein all of the VM/OS processors stall, while waiting for the blocked processor to perform some operation.

Therefore, there is a need for a system and/or method for virtual real memory that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved virtual real memory system.

It is a further aspect of the present invention to provide for an improved virtual real memory method.

It is a further aspect of the present invention to provide for an improved virtual real memory completed page fault restoration process notification system.

It is a further aspect of the present invention to provide for an improved virtual real memory completed page fault restoration process notification method.

The aforementioned aspects and other objectives and advantages can now be achieved as described herein. A method for providing virtual real memory includes receiving a request for a memory page from a requestor. A system determines whether the requested memory page is available. In the event the requested memory page is available, the system satisfies the request. In the event the requested memory page is not available, the system generates a page fault interrupt, wherein the page fault interrupt comprises a first page fault correlation number (PFCID) identifying a restorative process, and wherein the restorative process is configured to restore the requested memory page to available memory. The system monitors a plurality of pending processes and determines whether the restorative process is complete. In the event the restorative process is complete, the system notifies the requestor that the restorative process is complete.

In an alternate embodiment, a system comprises a main memory. A memory array couples to the main memory, and the memory array is configured for virtual memory and comprises memory pages. A memory controller couples to the memory array and is configured to receive page requests identifying a requested memory page from a requester and to determine whether a requested memory page is resident in the memory array. In the event a requested memory page is not resident in the memory array, the memory controller identifies a restorative process that will result in the requested memory page being resident in the memory array, and generates a PFCID indicating the identified restorative process. The memory controller sends the requester an expropriation notification comprising a virtual real memory page fault indicator and a PCFID. The system monitors pending processes to determine whether the identified restorative process is complete. In the event the identified restorative process is complete, the memory controller notifies the requestor.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an improved virtual real memory system in accordance with a preferred embodiment; and

FIG. 2 illustrates a high-level flow diagram depicting logical operational steps of an improved virtual real memory method, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus or otherwise tangible medium that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

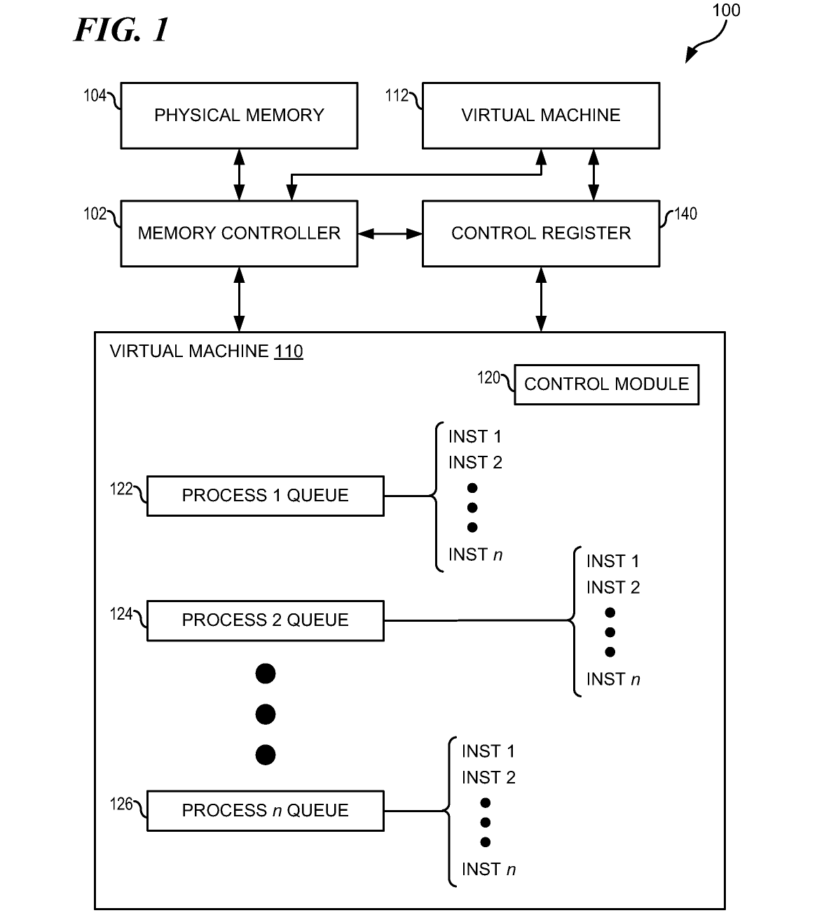

Referring now to the drawings, FIG. 1 is a high-level block diagram illustrating certain components of a system 100 for improved virtual real memory, in accordance with a preferred embodiment of the present invention. System 100 comprises a memory controller 102.

Memory controller 102 is an otherwise conventional memory controller, modified as described below. More specifically, in one embodiment, memory controller 102 is a virtual real memory (VRM) module of a computer platform. Generally, in one embodiment, memory controller 102 is configured as an interface between a virtual machine and a virtualized memory space.

For example, in the illustrated embodiment, memory controller 102 couples to physical memory 104. Generally, physical memory 104 is an otherwise conventional physical, or real, memory, configured for virtual memory. That is, physical memory 104 comprises a finite amount of physical data storage space, which memory controller 102 manages so as to appear to virtual machines as a larger available storage space than is physically present.

Generally, in the illustrated embodiment, memory controller 102 implements an improved virtual real memory protocol. As described above, virtual memory schemes implement memory addresses representing a larger physical memory space than is actually present in the physical memory. Accordingly, in one embodiment, memory controller 102 loads memory pages from an auxiliary storage media (not shown) into physical memory 104.

As physical memory 104 comprises a finite storage space, there is a limited number of memory pages loaded into, or resident on, physical memory 104 at any given time. Processes operating on one or more virtual machines of system 100 request memory pages from time to time, some of which are not resident on physical memory 104 when the requester process requests the requested memory page. Memory controller 102 services memory page requests as described in more detail below.

In the illustrated embodiment, system 100 includes a plurality of virtual machines (VMs), two of which are shown as VM 110 and VM 112. In one embodiment, each of VM 110 and VM 112 is an otherwise conventional virtual machine, adapted as described below. Generally, a virtual machine is a discrete execution environment in a computing system. In some embodiments, the virtual machines of system 100 share a single processor. In other embodiments, the virtual machines share a plurality of processors. In one embodiment, one or more of the virtual machines of system 100 is an operating system (OS).

Generally, virtual machines comprise a plurality of processor instructions in a queue or other prioritized execution order, as one skilled in the art will understand. Further, in the illustrated embodiment, virtual machines support multiple independent processes or threads. Each virtual machine includes a control module configured to manage the processes of the virtual machine.

For example, in the illustrated embodiment, VM 110 includes a control module 120 configured to manage a plurality of process queues, shown as process queue 122, process queue 124, and process queue 126. As illustrated, each of process queue 122, process queue 124, and process queue 126 comprises a plurality of instructions for execution in a specified order.

One skilled in the art will understand that each instruction comprises a variety of types of instruction, such as, for example, a load/store, a read, a write, and other well-known instructions. Some instructions request access to virtual memory pages of the virtual memory space embodied in physical memory 104.

In the illustrated embodiment, the processes of VM 110 request memory pages from control module 120, which in turn requests memory pages from memory controller 102. In one embodiment, each virtual machine also implements a virtual memory protocol with respect to the applications and/or processes of the associated virtual machine. For example, VM 110 implements a virtual memory protocol that is transparent to the VM 110 processes/applications.

As such, VM 110 from time to time expropriates, or otherwise requests memory controller 102 to evict, memory pages from physical memory 104, referred to herein as “OS expropriation.” OS expropriation also includes conditions wherein VM 110 expropriates pages from a local storage (not shown). Ordinarily, VM 110 expropriates memory pages in order to make room for memory pages requested by one of the processes of VM 110. When a process subsequently requests an expropriated memory page, VM 110, particularly in the OS embodiment, generates a page fault error, which notifies the requestor process that the requested page is unavailable.

In one embodiment, VM 110 generates an expropriation notification that indicates that VM 110 has expropriated the requested memory page. In an alternate embodiment, VM 110 generates a page fault error that stalls the requester process, generally blocking the requestor process until a restoration process has restored the memory page to physical memory 104.

Similarly, in the illustrated embodiment, memory controller 102 from time to time expropriates, or otherwise evicts, memory pages from physical memory 104, referred to herein as “memory controller expropriation.” In one embodiment, memory controller 102 expropriates memory pages in order to make room for memory pages requested by one of the virtual machines or one of the processes of the virtual machines. When a process or virtual machine requests a memory page that is not resident in physical memory 104, memory controller 102 generates a page fault error.

One skilled in the art will understand that there are a variety of conditions that can cause requested memory pages to be not resident in physical memory when requested. For example, a requested memory page might not yet have been loaded into physical memory at the time a process requests it. When a process or virtual machine subsequently requests an expropriated memory page, memory controller 102 generates a page fault error, which notifies the virtual machine associated with the requestor process that the requested page is unavailable.

In one embodiment, memory controller 102 generates an expropriation notification that indicates that the memory controller has expropriated the requested memory page. In one embodiment, the expropriation notification comprises a distinct interrupt vector. In an alternate embodiment, the expropriation notification comprises a bit in a status register that embodies secondary interrupt cause information. In one embodiment, an expropriation notification comprises a page fault correlation identifier (PFCID) and an indicator that the requested memory page has been expropriated in a memory controller expropriation, as opposed to an OS expropriation, or other operation.

Generally, a PFCID is a number identifying a restorative process that will cause the requested memory page to become resident in physical memory 104, and therefore accessible to the requestor. In one embodiment, the PFCID is a function of the address of the requested memory page. In an alternate embodiment, the PFCID is a function of an address of a control register 140 wherein memory controller 102 maintains a status of the requested memory page.

In the illustrated embodiment, control register 140 is an otherwise conventional register or other suitable storage and/or data structure. In one embodiment, control register 140 is a dedicated register configured to store the PFCID. In an alternate embodiment, control register 140 is a memory queue. In an alternate embodiment, control register 140 is a reserved main storage memory location. In one embodiment, memory controller 102 stores information on the status of the restorative process in control register 140.

In one embodiment, the virtual machine associated with the requester process exchanges the received PFCID for an alternate PFCID, generated by the virtual machine. In one embodiment, the alternate PFCID is a function of an identifier of the requester process. In an alternate embodiment, the alternate PFCID is a function of a control structure address associated with the virtual machine.

After sending the expropriation notification to the requester virtual machine, the memory controller 102 monitors the executing processes for the identified restorative process. In one embodiment, the requestor virtual machine also monitors the executing processes for the identified restorative process.

While the identified restorative process is incomplete, the requested memory page is not resident in physical memory 104. Accordingly, after receiving an expropriation notification, VM 110 blocks the requester process from further execution. In one embodiment, VM 110 blocks the requester process from further execution, and allows execution of instructions from other processes.

In the illustrated embodiment, memory controller 102 determines whether the restorative process has completed. While the restorative process has not completed, memory controller 102 processes other memory page requests. When memory controller 102 determines that the restorative process has completed, memory controller 102 sends a subvention notification to the virtual machine associated with the requestor process.

Generally, a subvention notification indicates to the requestor process virtual machine that the restorative process has completed. In one embodiment, the subvention notification comprises the PFCID sent to the virtual machine by memory controller 102. In an alternate embodiment, the subvention notification comprises the alternate PFCID registered by the virtual machine in exchange for the original PFCID.

In one embodiment, the subvention notification comprises an active message to the requester virtual machine. In an alternate embodiment, the subvention notification comprises updating a register or other predetermined storage location that is monitored by the requestor virtual machine (i.e., the VM associated with the requester process). In one embodiment, memory controller 102 sends a subvention notification by updating the restorative process state as stored in control register 140. In one embodiment, memory controller 102 places a message in a message queue of the requester virtual machine. In an alternate embodiment, memory controller 102 sends an interrupt to the requestor virtual machine.

Having received the subvention notification, the requester virtual machine unblocks the requester process, which allows the requestor process to continue though its instruction queue. As the restorative process has restored the requested memory page to they accessible physical memory, the requestor process carries out whatever instruction required the memory page, and continues its ordinary operations.

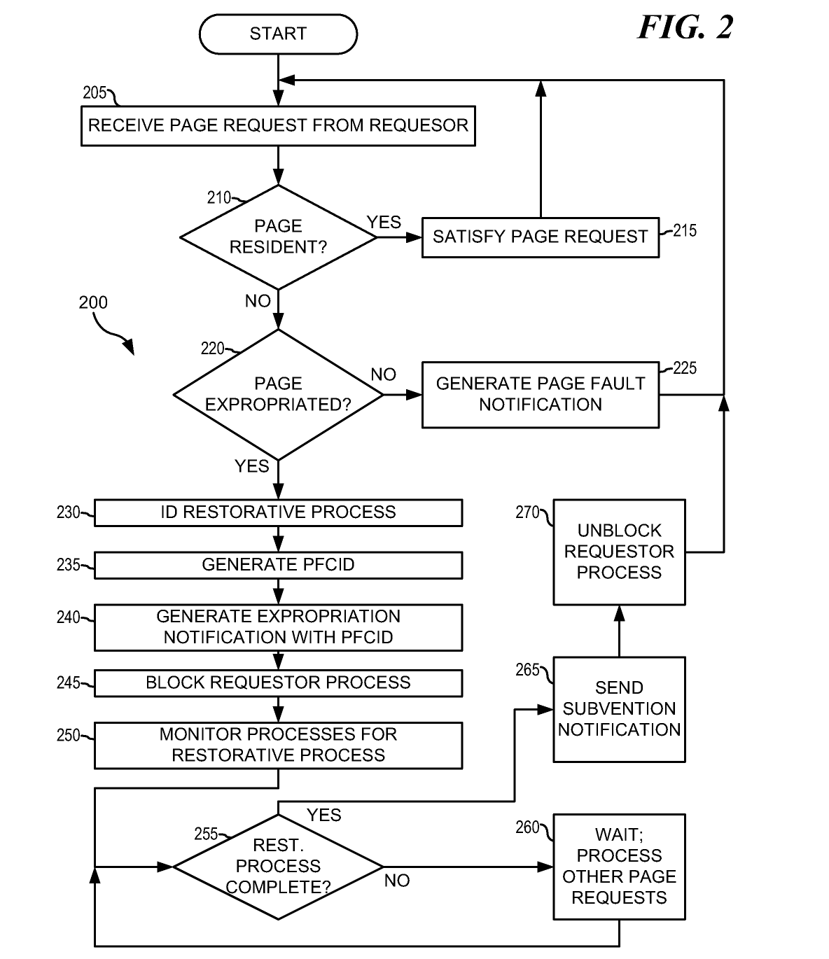

Thus, the embodiments disclosed with respect to FIG. 1 offer an improved virtual real memory that overcomes some of the disadvantages and shortcomings associated with Prior Art systems and methods, as described in more detail below. More particularly, in one embodiment, system 100 operates as described with reference to FIG. 2.

FIG. 2 illustrates one embodiment of a method for virtual real memory. Specifically, FIG. 2 illustrates a high-level flow chart 200 that depicts logical operational steps performed by, for example, system 100 of FIG. 1, which may be implemented in accordance with a preferred embodiment. Generally, memory controller 102 and/or control module 120 performs the steps of the method, unless indicated otherwise.

As indicated at block 205, the process begins, wherein memory controller 102 receives a request for a memory page, from a requestor associated with a virtual machine. For example, in one embodiment, memory controller 102 receives a request for a memory page from virtual machine 110. Next, as indicated at decisional block 210, memory controller 102 determines whether the requested memory page is resident in the physical memory.

If at block 210 the requested memory page is resident in the physical memory, the process continues along the YES branch to block 215. Next, as indicated at block 215, memory controller 102 retrieves the requested memory page from physical memory 104 and satisfies the memory page request. The process returns to block 205, wherein the memory controller 102 receives another memory page request.

If at block 210 the requested memory page is not resident in physical memory, the process continues along the NO branch to decisional block 220. Next, as indicated at decisional block 220, memory controller 102 determines whether the requested memory page is not resident because the memory page has been expropriated.

If at block 220 the requested memory page is not resident but the memory page has not been expropriated, the process continues along the NO branch to block 225. Next, as indicated at block 225, memory controller 102 generates a page fault notification, sends the generated notification to the memory page requestor, and returns to block 205.

If at block 220 the requested memory page is not resident and the memory page has been expropriated, the process continues along the YES branch to block 230. Next, as indicated at block 230, the memory controller 102 identifies a restorative memory process that will restore the non-resident page to the physical memory. In one embodiment, the restorative process causes the non-resident page to load from an auxiliary storage into physical memory 104.

Next, as indicated at block 235, memory controller 102 generates a page fault correlation identifier (PFCID) based on the identified restorative process. As described above, in one embodiment, the PFCID is a function of the address of the requested memory page. In an alternate embodiment, the PFCID is a function of an address of a control register 140 wherein memory controller 102 maintains a status of the requested memory page.

Next, as indicated at block 240, memory controller 140 generates an expropriation notification based on the PFCID. As described above, generally, an expropriation notification comprises the PFCID and an indicator that the requested memory page has been expropriated, as opposed to a non-expropriation notification as described above at block 225. Additionally, in one embodiment, the expropriation notification includes an indicator that the requested memory page has been expropriated by memory controller 102, in a memory controller expropriation, to distinguish the operation from one in which some other requestor, such as an operating system and/or VM 110, for example, expropriated the requested memory page in an OS expropriation.

As described above, in one embodiment, the virtual machine associated with the requester process exchanges the received PFCID for an alternate PFCID, generated by the virtual machine. In one embodiment, the alternate PFCID is a function of an identifier of the requester process. In an alternate embodiment, the PFCID is a function of a control structure address associated with the virtual machine.

Next, as indicated at block 245, memory controller 102 and/or the associated virtual machine blocks the requester process from further execution. In one embodiment, VM 110 blocks the requestor process from further execution, and allows execution of instructions from other processes. In an alternate embodiment, VM 110 blocks an application associated with the requester process from further execution, and allows execution of instructions from other applications and/or processes.

Next, as indicated at block 250, memory controller 102 and/or the associated virtual machine monitors the executing processes for the identified restorative process. In one embodiment, both the memory controller 102 and the associated virtual machine monitor the executing processes for the identified restorative process. In an alternate embodiment, only the memory controller 102 monitors the executing processes for the identified restorative process.

Next, as indicated at decisional block 255, memory controller 102 determines whether the restorative process has completed. If at block 255 the restorative process has not completed, the process continues along the NO branch to block 260. Next, as indicated at block 260, memory controller 102 waits and/or processes other memory page requests from virtual machines, processes, and/or applications other than the blocked process.

If at block 255 the restorative process has completed, the process continues along the YES branch to block 265. Next, as indicated at block 265, memory controller 102 sends a subvention notification to the virtual machine associated with the requester process. As described above, in one embodiment, memory controller 102 places a message in a message queue of the associated virtual machine. In an alternate embodiment, memory controller 102 sends an interrupt to the associated virtual machine. In one embodiment, the subvention notification comprises the PFCID, whether generated by the memory controller 102, or as exchanged by the associated virtual machine.

Next, as indicated at block 270, the memory controller 102 and/or the associated virtual machine unblocks the requestor process, and the process described herein returns to block 205.

Thus, in one embodiment, system 100 provides an improved virtual real memory system and method. Specifically, in response to a memory page request, from a requester process, for a memory page that has been expropriated by the memory controller, the memory controller provides an expropriation notification to a virtual machine associated with the requester process. The expropriation notification includes a PFCID identifying a restorative process that will cause the requested memory page to become available to the requestor process. Until the restorative process completes, the virtual machine blocks the requestor process and allows instructions to execute from other processes and/or applications. The memory controller monitors executing processes for the restorative process, and when the restorative process completes, the memory controller notifies the associated virtual machine through a subvention notification. Upon receipt of the subvention notification, the virtual machine unblocks the requester process, which continues with the instruction requesting the restored requested memory page.

Accordingly, the disclosed embodiments provide numerous advantages over other methods and systems. For example, the disclosed embodiments reduce latency caused by process stalls while waiting for expropriated memory pages to be restored to accessible memory. Additionally, the disclosed embodiments also provide a mechanism by which a virtual machine can selectively block processes that are stalled while waiting for restorative processes, allowing processes that are not stalled. Accordingly, the disclosed embodiments improve virtual real memory protocols, systems, and methods. One skilled in the art will recognize numerous other technical advantages.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A method for providing virtual real memory, comprising:
receiving a request for a memory page from a requester;
determining whether the requested memory page is available;
in the event the requested memory page is available, satisfying the request;
in the event the requested memory page is not available, generating a page fault interrupt;
wherein the page fault interrupt comprises a first page fault correlation number (PFCID) identifying a restorative process;
wherein the restorative process is configured to restore the requested memory page to available memory;
monitoring a plurality of pending processes;
determining whether the restorative process is complete; and
in the event the restorative process is complete, notifying the requester that the restorative process is complete.

2. The method of claim 1, further comprising:
identifying a process requesting the memory page; and
blocking the identified process until the restorative process is complete.

3. The method of claim 1, wherein the requestor performs the steps of monitoring a plurality of pending processes and determining whether the restorative process is complete.

4. The method of claim 1, further comprising generating a second PFCID based on the first PFCID.

5. The method of claim 1, wherein the first PFCID is a function of a memory address of the requested memory page.

6. The method of claim 1, wherein the PFCID is a memory address of a control structure comprising state information of the restorative process.

7. The method of claim 1, wherein notifying the requestor that the restorative process is complete comprises storing state information in a register.

8. The method of claim 1, wherein notifying the requestor that the restorative process is complete comprises generating an interrupt.

9. The method of claim 1, wherein notifying the requestor that the restorative process is complete comprises placing a message in a memory queue structure.

10. A system, comprising:
a main memory;
a memory array coupled to the main memory, the memory array configured for virtual memory and comprising memory pages;
a memory controller coupled to the memory array and configured to:
receive page requests identifying a requested memory page from a requester;
determine whether a requested memory page is resident in the memory array;
in the event a requested memory page is not resident in the memory array, identify a restorative process that will result in the requested memory page being resident in the memory array;
generate a PFCID indicating the identified restorative process;
send the requester an expropriation notification comprising a virtual real memory page fault indicator and a PCFID;
monitor pending processes to determine whether the identified restorative process is complete; and
in the event the identified restorative process is complete, notify the requester.

11. The system of claim 10, wherein the PFCID is a function of a memory address of the requested memory page.

12. The system of claim 10, wherein the PFCID is a memory address of a control structure comprising state information of the restorative process.

13. The system of claim 10, wherein notifying the requester comprises storing state information in a register.

14. A processor comprising a computer program product for providing virtual real memory, the computer program product having a tangible computer-readable medium with a computer program embodied thereon, the computer program comprising:
computer code for receiving a request for a memory page from a requester;
computer code for determining whether the requested memory page is available;
computer code for, in the event the requested memory page is available, satisfying the request;
computer code for, in the event the requested memory page is not available, generating a page fault interrupt;
wherein the page fault interrupt comprises a first page fault correlation number (PFCID) identifying a restorative process;
wherein the restorative process is configured to restore the requested memory page to available memory;
computer code for monitoring a plurality of pending processes;
computer code for determining whether the restorative process is complete; and
computer code for, in the event the restorative process is complete, notifying the requester that the restorative process is complete.

15. The processor of claim 14, further comprising:
computer code for identifying a process requesting the memory page; and
computer code for blocking the identified process until the restorative process is complete.

16. The processor of claim 14, wherein the requestor monitors a plurality of pending processes and determines whether the restorative process is complete.

17. The processor of claim 14, further comprising computer code for generating a second PFCID based on the first PFCID.

18. The processor of claim 14, wherein the PFCID is a memory address of a control structure comprising state information of the restorative process.

19. The processor of claim 14, wherein notifying the requestor that the restorative process is complete comprises storing state information in a register.

20. The processor of claim 14, wherein notifying the requestor that the restorative process is complete comprises placing a message in a memory queue structure.
